(19) United States
(12) Patent Application Publication
(10) Pub. No.: US 2006/0032558 A1
(43) Pub. Date: Feb. 16, 2006

(54) Titanium aluminide intermetallic composites

(76) Inventor: Scott Holloway, Stillwater, MN (US)

Correspondence Address: Miller, Canfield, Paddock and Stone P.L.C.;c/o Robert Kelley Roth, Suite 2500, 150 West Jefferson Ave., Detroit, MI, 48226, US

(21) Appl. No.: 10/917,110

(22) Filed: Aug. 12, 2004

(51) Int. Cl. C22C 21/00; C01G 23/04

(52) U.S. Cl. 148/437; 423/598

(57) ABSTRACT

An intermetallic composite and method of making an intermetallic composite is disclosed comprising a porous titanate preform of the formula εₓTi_{y}O_{z}, where ε represents an element reduceable by molten aluminum to form an aluminate of the formula εᵢAⱼOₖ. Adding aluminum and heating the preform sufficient to melt the aluminum results in formation of a post-combustion intermetallic composite comprising both titanium aluminide and 68 -aluminate.

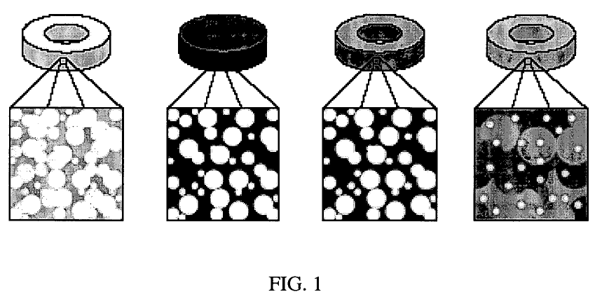

### FIELD OF THE INVENTION

This invention relates to improvements in titanium aluminide intermetallic composites, and more particularly to improvements in titanium aluminide intermetallic composites suitable for use in automotive and aerospace applications.

### BACKGROUND OF THE INVENTION

The production of titanium aluminide (“TiAl”) intermetallic matrix composites (“IMC”) (or simply Titanium Aluminide Composite “TAC”), has been studied by many academic and commercial organizations in recent years. Intermetallics are understood by those skilled in the art to mean binary alloys with phases in the mid-composition range. For example, binary alloys of titanium and aluminum can comprise the phases TiAl₃, TiAl, or Ti₃Al, or mixtures of these phases. Of these intermetallic phases, TiAl has relatively good mechanical properties for use as an engineering material, including high stiffness, strength, ductility and temperature resistance. The important crystal phases in an alloy are usually given a designation using a greek letter, and in this case TiAl is referred to as γ-TiAl, or simply the γ phase. The phases where titanium is approximately 20-80% of the alloy by weight are considered to be mid-composition range, with the alloy titanium and 35-41 weight percent aluminum being most preferred.

The primary application for TACs has been the replacement of cast iron and aluminum matrix composites (“AMC”) in automotive brake rotors. Other applications include valve stems, seats, tappets, rocker arms, cylinder liners, etc. and other engine components in the automotive industry as well as turbine rotor blades and munitions components in aerospace and military applications. TACs are advantageous because they can have low density (3.4-3.7 g/cc), high Young's modulus (170-210 GPa), high wear resistance, and operational temperatures as high as 900° C., which is significantly higher than the typical melt point for AMC (˜600° C.). Further advantages include relatively low raw materials and processing costs due to the fact that TAC is produced by the combustion of a porous titanium (IV) oxide (TiO₂) “preform” (a vacuum formed part having a porous structure) that has been infiltrated with molten aluminum using common die casting techniques.

Combustion synthesis to form a titanium aluminide intermetallic composite comprises the steps of fabricating a porous preform with TiO₂ particles, infiltrating the preform with aluminum, thereby forcing out the air and to form a pre-combustion composite, heating the composite above 660° C. to completely melt the aluminum and allow the titanium oxide to react with the aluminum and form a post-combustion intermetallic composite. Since the combustion synthesis of TAC is typically carried out at a furnace temperature of about 850° C., relatively little process energy is required to produce a material which ultimately has a melting temperature of about 1450° C.
3TiO₂(s)+7 Al(l) 3TiAL(s)+2Al₂O₃(s) Equation (1)

The post-combustion intermetallic composite consists principally of in situ alumina (Al₂O₃) particles in a matrix of titanium aluminide intermetallic. The combustion synthesis of titanium aluminide may also produce a small amount of Ti₃Al intermetallic. However, as long as the stoichiometry is controlled by holding the TiO₂ volume precisely, the TiAl phase will dominate. Further, when the volume fraction of TiO₂ particles is selected to satisfy the stoichiometry of Equation 1, the reaction produces the appropriate quantities to Ti and Al (50 at %, or 36 wt %) to construct a desired γ-TiAl phase intermetallic matrix.

The reaction shown in Equation (1) is exothermic. Based on the standard state thermodynamic properties, the reaction has a heat of fusion (ΔH°_{f}) of approximately −627 kJ/mol. The change in entropy (ΔS°) is −104 J/mol-K, which suggests that the reaction increases order within the material system. However, the Gibbs free energy of formation (ΔG°_{f}) remains negative, about −596 kJ/mol, which means that the reaction could occur spontaneously. While this analysis suggests that this reaction can occur at room temperature, it has been found that combustion synthesis will not become fully activated until all of the aluminum has melted. This suggests that there is a significant barrier in terms of kinetics preventing the TiO₂ and aluminum from reacting once the preform has been infiltrated and prior to placing the material in a furnace at 850° C. Further, while the aluminum is certainly molten during the die casting process, the very nature of die casting removes heat from the material at such a high rate that the combustion reaction can not be initiated. The reaction only runs when the rate of gain of heat due to the oxidation reaction is greater than the rate of heat loss.

According to the stoichiometry of the reaction shown in Equation (1), the volume fraction (Vf) of TiO₂ in the pre-combustion composite needed to fully react all of the aluminum is 44.7% based on a density of 4.23 g/cc for TiO₂, and a density of 2.70 g/cc for pure aluminum. Therefore, the average density of the pre-combustion composite is 3.38 g/cc. When the reaction is complete, the densities of the products are 3.66 g/cc for TiAl (Vf=48.5%), and 3.96 g/cc for Al₂O₃ (Vf=40.7%), for an average density of 3.80 g/cc for the post-combustion composite. This increase in average density in the final composite leads to the formation of approximately 10.8% porosity by volume. This increased porosity has a significant detrimental effect with regards to the mechanical properties of the material.

Several techniques have been tried to reduce the problem of porosity. One method for reducing porosity in the post-combustion composite is to use other forms of titanium oxide, the two most common being titanium (II) oxide (TiO), and titanium (III) oxide (Ti₂O₃). Both of these materials can react with aluminum to form TACs.

The densities of TiO and Ti₂O₃ are 4.95 g/cc and 4.49 g/cc, respectively, higher than TiO₂ density of 4.23 g/cc. A higher density titanium oxide precursor will result in less porosity in the final post-combustion composite. As with the material produced using TiO₂, the reactions are exothermic and the reactions are also nominally spontaneous. The post-combustion density of the TAC made using Ti₂O₃ is 3.78 g/cc with a Vf of porosity of 7.5%, and post-combustion density of the TAC made using TiO is 3.75 g/cc, with a Vf of porosity of 1.8% (both better than TiO₂).

While the initial volume fraction of the different titanium oxide precursors does not vary greatly, the stoichiometry of the combustion reaction has a significant effect on the post-combustion density and the volume fraction of porosity. With the lowest density and the lowest porosity, it is reasonable to assume that the TAC produced using the TiO precursor is the best overall material. However, this advantage is negated by the significant difference in the cost of TiO compared to TiO₂ (about ten times by weight), which essentially means the TAC produced using this oxide is cost-prohibitive for most applications. Similarly, the cost of Ti₂O₃ is about five times that of TiO₂.

Another method for reducing porosity is to blend inert constituents into the initial preform, such as alumina particles of fibers. One possible material which is commonly used as a reinforcement material for metal matrix composites (MMC) is SAFFIL High Alumina Fiber, which consists of mostly alumina fiber with some silica. While it is possible to reduce the total porosity in the TAC by including SAFFIL fiber, it is not possible to eliminate the porosity completely. This is simply due to the fact that the inert fiber takes up volume, and the relative volume fractions of titanium oxide and aluminum must also be adjusted in order to satisfy the stoichiometry of the combustion reaction.

It is possible to calculate the reduction in porosity as a function of the volume fraction of the inert constituent. The reduction in the required amount of titanium oxide precursor is equal to the volume fraction of the inert constituent. Likewise, the reduction in the volume fraction of porosity is equal to the volume fraction of the inert constituent. The practical maximum limit for inert constituents is a volume fraction of about 30%. Therefore, for TAC materials based on TiO₂ and Ti₂O₃, the inclusion of inert reinforcement materials has little practical commercial significance. However, when inert constituents such as SAFFIL fiber are combined with the TiO precursor, the result is a reasonable reduction in cost. In the case of a TiO with a SAFFIL fiber volume fraction of 30%, the post-composition composite is 48.4% (Vf) TiAl, 50.3% (Vf) Al₂O₃ (30% SAFFIL+20.3% in situ Al₂O₃), and 1.3% porosity by volume. While this material represents a significant improvement over the composite produced using TiO₂ (10.8% porosity), it is still cost-prohibitive with regards to many production applications, especially in the automotive industry. Moreover, while 1.3% porosity is relatively small, it can still cause significant problems with regards to fatigue and fracture toughness in the high-temperature structural applications which these materials have been designed for.

In summary, two options have been considered for reducing porosity caused by densification in the combustion synthesis of titanium aluminide composites; the use of different titanium oxide precursors, and the inclusion of inert reinforcement materials. While both methods may or may not result in a better performing material, neither achieves the original objective of producing a zero-porosity composite. It would be highly desirable to provide a material selection for a precursor which would result in the formation of a zero porosity composite.

### SUMMARY OF THE INVENTION

In accordance with a first aspect, a preform for an intermetallic composite, an intermetallic composite and a method of making an intermetallic composite is disclosed comprising a porous intermetallic composite preform of the formula εₓTi_{y}O_{z}, where ε represents an element reduceable by molten aluminum to form an aluminate of the formula εⱼAlⱼOₖ. Adding aluminum and heating the preform sufficient to melt the aluminum results in formation of a post-combustion intermetallic composite comprising both titanium aluminide and ε-aluminate.

From the foregoing disclosure and the following more detailed description of various preferred embodiments it will be apparent to those skilled in the art that the present invention provides a significant advance in the technology of intermetallic composites. Particularly significant in this regard is the potential the invention affords for providing a zero porosity intermetallic composite. Additional features and advantages of various preferred embodiments will be better understood in view of the detailed description provided below.

### DETAILED DESCRIPTION OF CERTAIN PREFERRED EMBODIMENTS

It will be apparent to those skilled in the art, that is, to those who have knowledge or experience in this area of technology, that many uses and design variations are possible for the intermetallic composite disclosed here. The following detailed discussion of various alternative and preferred features and embodiments will illustrate the general principles of the invention with reference to an intermetallic composite suitable for use in automotive and aerospace applications where high temperature resistance is desirable. Other embodiments suitable for other applications will be apparent to those skilled in the art given the benefit of this disclosure.

In accordance with a highly advantageous feature, a titanium aluminide intermetallic composite with improved properties can be formed with a new titanate preform of the form εₓTi_{y}O_{z}, where ε represents any element that will be reduced by molten aluminum to form an aluminate (εᵢAlⱼOₖ). Further, it is preferable that the element ε should be a common alloying element and should be of significantly lower density than aluminum in order to maximize the reduction in density resulting from the titanate to aluminate transformation. The titanate should also be a readily available commodity material, with a cost similar to that of TiO₂. One such element which satisfies these conditions is the alkali metal lithium (Li). When lithium is used, the titanate preform is Lithium titanate, Li₂TiO₃ and the integer x is 2, y is 1 and O is 3. Lithium titanate, Li₂TiO₃ has a density of 3.46 g/cc, and lithium aluminate, LiAlO₂ has a density of 2.62 g/cc. Lithium titanate is reduced by molten aluminum to form lithium aluminate, and the resulting change in density is about −24.3%. The reduction reaction is of the form:
2Li₂TiO₃(s)+5Al(l) 2TiAl(s)+3LiAlO₂(s)+Li(s) Equation 2

Analysis of the stoichiometry yields an optimal volume fraction of lithium titanate of 55.9% percent in a porous preform in order to react all of the molten Al. The reaction produces an increase in the total volume of the material system of 14.4%, instead of the decrease leading to porosity problems seen when only titanium oxides are used in the preform.

Excess Li produced is treated in Equation 2 as a separate phase, which has a volume fraction of 11.5% in the post combustion composite. Free Li may also form a new phase in the intermetallic matrix, resulting in a two-phase solid solution of the form γ-TiAl and a lithium-titanium-aluminum substitutional solid solution (due to the low solubility of Li in Al and Ti). Given anticipated volume fractions (with low amounts of lithium by weight), normally the γ-TiAl phase would predominate. If the Li is incorporated into the post-combustion intermetallic matrix without significantly impacting its density, the material system will still have a significant increase in total volume which could pose a new problem due to residual stress.

Calculations based on the available thermodynamic data for lithium titanate and lithium aluminate show that the reaction is in fact exothermic, with a heat of fusion of −297 kJ/mol, and spontaneous, with a Gibbs free energy of formation of −285 kJ/mol. Due to the fact that Li₂O is a relatively stable oxide, it is also theoretically possible that instead of forming lithium aluminate, the reduction of lithium titanate will result in the formation of separate phases of aluminum oxide and lithium oxide. However, the formation of lithium aluminate provides a greater change in free energy, and is therefore more likely to occur than the formation of separate phases.

Titanium oxide compounds in preforms results in a decrease in the total volume of the post-combustion intermetallic composite, and lithium titanate compounds in preforms results in an increase in the total volume of the post-combustion intermetallic composite. Therefore, in accordance with a highly advantageous feature, combustion synthesis of titanium aluminide composites can be achieved with no net change in volume through optimal blending of titanium oxide and lithium titanate in a preform. The combustion synthesis to produce a post-combustion intermetallic composite having no net change in volume follows the reaction:
TiO₂+2Li₂TiO₃(s)+7Al(l) 3TiAl(s)+4LiAlO₂(s) Equation 3

For the preform precursor mixture containing titanium (IV) oxide (TiO₂) and lithium titanate (Li₂TiO₃), no net change in volume is achieved with a porous preform having a total volume fraction of 50.6%, with the preform comprising 53.1% TiO₂ and 46.9% Li₂TiO₃ by weight. The reaction proceeds until all of the lithium titanate is exhausted, at which point the remaining TiO₂ and aluminum continue to react according to Equation (1). The stoichiometrically balanced equation also reveals that for this blended system, there is no longer the formation of free Li, which means that the intermetallic matrix is made up entirely of the γ-TiAl phase, which has a volume fraction of 43.3% in the postcombustion composite. The remaining volume consists of 41.7% LiAlO₂ and 15% Al₂O₃ (resulting from the secondary reaction), and the sum of these volume fractions confirms that there has been no net change in total volume. The ratios of materials added in the preform may be varied from those designed to achieve zero porosity, if desired. The reaction shown in Equation (3) is also exothermic and spontaneous, with a heat of fusion of −577 kJ/mol and a Gibbs free energy of formation of −555 kJ/mol.

Similar reactions can be run with other titanium oxides. For a precursor mixture of titanium (III) oxide, Ti₂O₃ and lithium titanate, Li₂TiO₃, the optimal preform volume fraction is 49.3%, with a composition of 57.3% Ti₂O₃ and 42.7% Li₂TiO₃ by weight. The governing reaction is:
Ti₂O₃+3Li₂TiO₃(s)+11Al(l) 5TiAl(s)+6LiAlO₂(s) Equation 4

This reaction is also balanced without the production of free lithium, which results in a volume fraction of the TiAl matrix of 49.6%, and volume fractions of 33.4% for the Li₂TiO₃ and 17.0% for the Al₂O₃. As with the intermetallic composite created from TiO₂, the reaction proceeds until the Li₂TiO₃ is exhausted, and then aluminum oxide is generated in a manner analogous to Equation 1. The heat of fusion for Equation (4) is −779 kJ/mol, and the Gibbs free energy of formation is −748 kJ/mol.

For a precursor mixture of titanium (II) oxide (TiO) and lithium titanate, Li₂TiO₃, the optimal preform volume fraction is 45.4%, with a composition of 84.6% TiO and 15.4% Li₂TiO₃ by weight. Less Li₂TiO₃ is required when blended with TiO compared to TiO₂. The governing reaction is:
TiO+Li₂TiO₃(s)+4Al(l) 2TiAl(s)+2LiAlO₂(s) Equation 5

As with the other blended preforms mixtures, the reaction equation is balanced without the production of free lithium, which results in a volume fraction of the TiAl matrix of 65.3%, and volume fractions of 11.1% for the Li₂TiO₃ and 23.6% for the Al₂O₃. The reaction proceeds until the Li₂TiO₃ is exhausted, and then aluminum oxide is generated in a manner analogous to Equation 1. The heat of fusion for equation (8) is −518 kJ/mol, and the Gibbs free energy of formation is −486 kJ/mol. Any of these preforms may be further blended with an inert reinforcement material such as, for example, Saffil High Alumina Fibre. Examples of intermetallic composites are provided below.

Example 1. Following the reaction of Equation 2, a porous preform is fabricated to define a part shape and comprises lithium titanate having a volume fraction of 55.9% (the rest of the preform is air). The porous preform is infiltrated with aluminum and heated to about 850° C. to melt the aluminum and maintain. sufficient heat to allow the reaction to be initiated and completed. The lithium titanate reacts with the aluminum to form a post-combustion intermetallic composite comprising 62.3% LiAlO₂ by volume fraction and 37.9% of a solid solution of a LiₓTi_{y}Al_{z} matrix. As discussed generally above, most of the matrix is γ-TiAl. That is, most of the solid solution would be just γ-TiAl, but excess lithium would occasionally replace a few aluminum atoms in the crystal structure of the matrix.

Example 2. Example 2 is similar to Example 1 but with the addition of Saffil High Alumina Fibre. This requires adjustments to the amounts of materials in the preform as follows: Lithium titanate: 47.6% by volume fraction, aluminum: 37.4% by volume fraction, Saffil High Alumina Fibre: 15% by volume fraction. The post-combustion intermetallic composite comprises 53.5% LiAlO₂ by volume fraction, 32.3% of a solid solution of a LiₓTi_{y}Al_{z} matrix, and 14.2% High Alumina Fibre. The volume fractions are adjusted based on volumetric expansion.

Example 3. A zero porosity titanium aluminide intermetallic composite is created from a preform comprising: TiO₂: 24.3% by volume fraction, Lithium titanate: 26.3% by volume fraction, aluminum: 49.4% by volume fraction. The post-combustion intermetallic composite is optimized to avoid a significant change in density, and comprises: 41.7% LiAlO₂, 43.3% TiAl matrix, and 15% Al₂O₃ by volume.

Example 4. A zero porosity titanium aluminide intermetallic composite is created from a preform comprising: Ti₂O₃: 28.2% by volume fraction, Lithium titanate: 21.1% by volume fraction, aluminum: 50.7% by volume fraction. The post-combustion intermetallic composite is optimized to avoid a significant change in density, and comprises: 33.4% LiAlO₂, 49.6% TiAl matrix, and 17% Al₂O₃ by volume.

Example 5. A zero porosity titanium aluminide intermetallic composite is created from a preform comprising: TiO: 38.4% by volume fraction, Lithium titanate: 7.0% by volume fraction, aluminum: 54.6% by volume fraction. The post-combustion intermetallic composite is optimized to avoid a significant change in density, and comprises: 11.1% LiAlO₂, 65.3% TiAl matrix, and 23.6% Al₂O₃ by volume.

Example 6. A zero porosity titanium aluminide intermetallic composite is created from a preform comprising: TiO₂: 20.7% by volume fraction, Lithium titanate: 22.3% by volume fraction, aluminum: 42.0% by volume fraction and Saffil high alumina fibre, 15% by volume fraction. The post-combustion intermetallic composite is optimized to avoid a significant change in density, and comprises: 35.4% LiAlO₂, 36.8% TiAl matrix, 12.8% Al₂O₃ and 15% Saffil high alumina fibre by volume.

Example 7. A zero porosity titanium aluminide intermetallic composite is created from a preform comprising: Ti₂O₃: 24.0% by volume fraction, Lithium titanate: 17.9% by volume fraction, aluminum: 43.1% by volume fraction and Saffil high alumina fibre, 15% by volume fraction. The post-combustion intermetallic composite is optimized to avoid a significant change in density, and comprises: 28.4% LiAlO₂, 42.2% TiAl matrix, 14.4% Al₂O₃, and 15% Saffil high alumina fibre by volume.

Example 8. A zero porosity titanium aluminide intermetallic composite is created from a preform comprising: TiO: 32.6% by volume fraction, Lithium titanate: 6.0% by volume fraction, aluminum: 46.4% by volume fraction. The post-combustion intermetallic composite is optimized to avoid a significant change in density, and comprises: 9.4% LiAIO₂, 55.5% TiAl matrix, 20.1% Al₂O₃, and 15% Saffil high alumina fibre by volume.

The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An intermetallic composite comprising, in combination:
a titanium aluminide and an alkali aluminate.

2. The intermetallic composite of claim 1 wherein the alkali metal is lithium.

3. The intermetallic composite of claim 1 further comprising a reinforcement material.

4. The intermetallic composite of claim 3 wherein the reinforcement material is alumina fibers.

5. The intermetallic composite of claim 1 having a porosity of less than 1.7 percent by volume.

6. The intermetallic composite of claim 1 having a porosity of less than 0.5%.

7. The intermetallic composite of claim 1 further comprising aluminum oxide.

8. A porous intermetallic composite preform of the formula εₓTi_{y}O_{z}, where ε represents an element reduceable by molten aluminum to form an aluminate of the formula εᵢAlⱼOₖ.

9. The porous intermetallic composite preform of claim 8 further comprising a titanium oxide.

10. The porous intermetallic composite preform of claim 9 wherein the titanium oxide comprises one of TiO₂, Ti₂O₃ and TiO.

11. The porous intermetallic composite preform of claim 9 wherein ε comprises lithium and the titanium oxide is TiO₂, and the volume fraction of the lithium titanate is 21-31% and the volume fraction of the titanium oxide is 20-30%.

12. The porous intermetallic composite preform of claim 8 further comprising a reinforcement material.

13. The porous intermetallic composite of claim 12 wherein the reinforcement material comprises alumina fibers.

14. A method of making an intermetallic composite comprising in combination, the steps of:
fabricating a preform from lithium titanate;
introducing aluminum to the preform to form a pre-combustion composite; and
heating the pre-combustion composite and forming a post-combustion intermetallic composite. composite.

15. The method of claim 14 wherein the post-combustion intermetallic composite comprises titanium aluminide and lithium aluminate.

16. The method of claim 14 wherein the preform further comprises a reinforcement material.
